(19) United States
(12) Patent Application Publication
(10) Pub. No.: US 2024/0239679 A1
(43) Pub. Date: Jul. 18, 2024

(54) FUMED ALUMINA POWDER WITH REDUCED MOISTURE CONTENT

(71) Applicant: EVONIK OPERATIONS GMBH, Essen (DE)

(72) Inventors: Mareike GIESSELER, Maintal (DE); Frank MENZEL, Hanau (DE); Alexander LYGIN, Griesheim (DE); Rainer GOLCHERT, Dieburg (DE)

(73) Assignee: EVONIK OPERATIONS GMBH, Essen (DE)

(21) Appl. No.: 18/560,392

(22) PCT Filed: May 3, 2022
(86) PCT No.: PCT/EP2022/061778

§ 371 Date: Nov. 12, 2023

(30) Foreign Application Priority Data
May 14, 2021 (EP) 21173827.3

(51) Int. Cl. C01F 7/44

(52) U.S. Cl. CPC C01F 7/44; C01P 2002/01; C01P 2002/72; C01P 2004/04; C01P 2004/51; C01P 2006/11; C01P 2006/12; C01P 2006/82

(57) ABSTRACT

Fumed alumina powder with reduced moisture content Surface unmodified fumed alumina powder comprising less than 5% by weight of alpha-Al₂O₃, as determined by XRD analysis, having a numerical average particle size d₅₀ of less than 5 μm, as determined by SLS, and a ratio R₁₅₀=KF₁₅₀/BET of the water content KF₁₅₀, as determined by Karl Fischer titration method after drying of the fumed alumina powder at 150° C. for 2 hours, to its BET surface area of not more than 0.0122 wt %×g/m², preparation method and the use thereof.

### FIELD OF THE INVENTION

The present invention relates to fumed alumina powders with relatively small particle size and low moisture content, the preparation method and the use thereof.

### BACKGROUND OF THE INVENTION

Fumed alumina powders are very useful additives for a variety of different applications. To name just some of these applications, fumed alumina can be used as rheology modifying or anti-settling agents for paints, coatings, silicones, and other liquid systems. Alumina powders can improve flowability of powders or optimize mechanical or optical properties of silicone compositions, as well as be used as fillers for pharmaceutical or cosmetic preparations, adhesives or sealants, toners and other compositions. Fumed alumina can be employed as a catalyst carrier, in chemical mechanical planarization (CMP) applications, in thermal insulation and in lithium ion batteries.

Fumed aluminas may comprise different crystallographic phases, such as alpha-, theta-, delta-, and gamma-Al₂O₃. The presence and the ratio of these crystallographic phases define to a large extent the physico-chemical properties of fumed alumina and its applicability in various fields.

Untreated fumed aluminum oxides are hydrophilic due to the presence of polar hydroxyl groups on their surface. Such untreated fumed aluminas tend to absorb substantial quantities of water, increasing the moisture content of such materials. A part of the absorbed water is weakly bound to Al₂O₃ and can be removed after drying, e.g. at about 100° C. for 1-2 hours. The content of such weakly-bound water may depend on the humidity of the environment, where the alumina is stored after its preparation. Another part of the absorbed water is bound to Al₂O₃ more strongly and cannot be removed upon drying at 150° C. for 2 h. The content of this strongly bound water is practically independent of the storage conditions. Total moisture content of aluminum oxide, including both types of the absorbed water, may be reliably measured by Karl-Fischer titration method.

In some applications, for instance in components for lithium ion batteries, such as in separators, electrodes, electrolyte, the presence of water is undesired.

Thus, WO2018149834A1 discloses preparation of mixed lithium metal oxide particles coated by fumed aluminum oxide and titanium dioxide and the use of this material in lithium ion batteries.

WO2020225018 Al discloses separator for a lithium ion battery, comprising an organic substrate coated with a coating layer comprising a binder and a surface treated fumed alumina.

Water present in such alumina additives would react with some water-sensitive components of the lithium ion battery, e.g. LiPF₆ often contained in the electrolyte and lead to decomposition thereof and releasing reactive substances such as HF facilitating deactivation of such batteries. Therefore, fumed aluminas with reduced moisture content are required or may be useful for such applications, where water-sensitive components are involved.

Though water weakly bound to fumed alumina can in many cases be removed by drying thereof under mild conditions, the water strongly bound to Al₂O₃ normally cannot be removed without significant changes of the structure and physico-chemical properties of the employed fumed alumina.

Therefore, the question how to obtain such fumed alumina powders with low moisture contents, remains open.

### DESCRIPTION OF THE PRIOR ART

A typical process for producing fumed alumina powders is described in WO 2005/061385 A2. Flame hydrolysis of aluminum chloride vapour and subsequent separation of a solid aluminum oxide from the gas stream is followed by a treatment of the solid product with steam for purification of alumina from residues of hydrogen chloride. The prepared alumina powder samples with tamped densities of 24-31 g/L and BET surface areas of 101-195 m²/g are predominantly amorphous or in the gamma phase and have a hydroxyl group content of 8.1-11.4 OH/nm², as determined by a reaction with lithium aluminum hydride. Presence of water during the flame hydrolysis process and the subsequent post-treatment of fumed alumina with steam or wet air results in fumed aluminum oxides with relatively high moisture contents (drying loss at 105° C. for 2 hours of up to 5 wt %).

Similarly, WO 2006067127 Al discloses a process for producing fumed alumina powders with BET surface areas of 49-175 m²/g and tamped densities of 26-64 g/L. The prepared alumina powders comprise up to 100% gamma-Al₂O₃, maximally 5-10% thetha-Al₂O₃, the balance being delta-Al₂O₃. The hydroxyl group content of the prepared samples determined by a reaction with lithium aluminum hydride varies in the range 9.1-10.2 OH/nm². Again, presence of water during the flame hydrolysis process and the subsequent post-treatment of fumed alumina with steam or wet air does not allow reducing the moisture content of the obtained alumina.

Fumed alumina powder with a BET surface area of 21 m²/g, comprising typically about 70% alpha-Al₂O₃, 20% delta-Al₂O₃, 10% gamma-Al₂O₃, can be prepared according to EP0395925A1 by a flame process using a relatively high flame temperature of 1200-1400° C. No special measures are taken in EP0395925A1 to reduce the moisture content of the obtained fumed aluminum oxides.

One possible way to reduce the moisture content of the fumed aluminum oxide powder, especially that of the strongly absorbed water, may be thermal treatment of alumina under exclusion of water. However, such thermal treatment, additionally to moisture content reduction, often leads to substantial structure changes reflected e.g. in significant BET surface reduction, particle agglomeration and modifications of the crystal structure phases of aluminum oxide.

Thus, according to EP0355481Al a predominantly gamma fumed alumina powder with a BET surface area of about 100 m²/g can be thermally treated in a flame with a temperature of >1200° C. to reduce the BET surface area down to 40 m²/g and obtain an alumina comprising 70-90% alpha-Al₂O₃.

WO 2010/069690 A1 discloses a process for preparing a fumed aluminum oxide powder with a BET surface area of 3-30 m²/g, comprising at least 85% by weight of alpha-aluminum oxide, and a very broad particle size distribution. This alumina powder is produced by a process, wherein fumed alumina granules with a predominantly gamma-Al₂O₃ phase and tamped density of at least 250 g/L are subjected to thermal treatment at 1300° C. or more and subsequently milled. It is emphasized in WO 2010/069690 A1 that only densified alumina precursors with a tamped density of at least 250 g/L, such as granules, can be used as precursors in the described process.

Thus, prior art does not teach how to obtain untreated (hydrophilic) fumed alumina powders with both low moisture and low alpha-aluminum oxide contents.

It is known from the prior art, that moisture content of fumed aluminum oxides can further be reduced by surface treatment of hydrophilic alumina with organosilanes. Thus, WO 2004/108595 A2 discloses a process for producing pyrogenically prepared surface modified aluminum oxide, comprising spraying alumina with a surface modifying agent in vapour form followed by a thermal treatment of the resulting mixture at 50-800° C. over a period of 0.5 to 6 h. This thermal treatment of the surface treated alumina serves the completion of the surface treatment reaction.

### PROBLEM AND SOLUTION

Depending on the preparation conditions, fumed alumina may comprise various allotropic forms (crystallographic phases), such as thermodynamically stable alpha-Al₂O₃ or different transition states such as gamma-, delta-, theta-Al₂O₃.

Each of these different allotropic forms of alumina have their unique physico-chemical properties, which define to a large extent a possible application field thereof. Thus, transition forms of Al₂O₃ typically have low densities and large BET surface areas and are particularly useful e.g. as catalyst supports or additives to lithium ion batteries. Therefore, one problem to be addressed by the invention is to provide a fumed alumina particularly suitable for above mentioned applications, particularly for use in lithium ion batteries, which consists of predominantly transition aluminum oxides, i.e. essentially no alpha-Al₂O₃.

To provide fumed aluminas particularly suitable for such water-sensitive applications as in lithium ion batteries, it is further desirable to decrease the moisture content of the aluminas. Especially, the content of strongly bound water, i.e. of that not removable under drying at 150° C. for 2 hours, in fumed alumina should be reduced. The reduced moisture content should further remain low in the fumed alumina under normal storage conditions thereof, e.g. in the presence of air humidity.

A still further problem addressed by the invention is that of providing good dispersibility and thixotropic properties of fumed alumina particles in various compositions, e.g. in silicones or lack compositions. Dispersibility and thixotropic properties of fumed aluminas are primarily associated with a relatively small alumina particle size, narrow particle size distribution and aggregation and agglomeration of the particles.

Reducing of moisture content upon thermal treatment often goes hand in hand with a crystallographic phase change, densification, significant BET surface reduction and particle agglomeration. Thus, it is quite difficult to obtain fumed transition alumina with a substantially reduced moisture content and simultaneously to keep the BET surface area high, density low and the alumina particles small and the particle size distribution thereof narrow. Therefore, it is quite challenging to simultaneously achieve a good dispersibility of fumed alumina particles and a low viscosity increase (thickening effect) in compositions filled with such aluminas.

Thus, the overall technical problem addressed by the present invention is that of providing a fumed alumina powder predominantly consisting of transition alumina phases, with a good dispersibility in compositions, a reduced moisture content, especially after storage in a humid environment. Further problem addressed by the invention is that of providing a method suitable for manufacturing such alumina powders in an efficient manner.

After various unsuccessful attempts, the inventors surprisingly found that the optimized inventive process allows preparation of such fumed alumina powders.

### Surface Unmodified Fumed Alumina Powder

The invention provides surface unmodified fumed alumina powder:
a) comprising less than 5% of alpha-Al₂O₃, as determined by XRD analysis, and having:
b) numerical average particle size d₅₀ of less than 5 μm, as determined by static light scattering (SLS) after 120 s of ultrasonic treatment at 25° C. of a 5% by weight dispersion of the alumina in water;
c) a ratio R₁₅₀=KF₁₅₀/BET of the water content KF₁₅₀, as determined by Karl Fischer titration method after drying of the fumed alumina powder at 150° C. for 2 hours, to its BET surface area of not more than 0.0122 wt %×g/m².

The term “alumina” in the context of the present invention relates to the individual compound (aluminum oxide, Al₂O₃), alumina-based mixed oxides, alumina-based doped oxides, or mixtures thereof. “Alumina-based” means that the corresponding alumina material comprises at least 70% by weight, preferably at least 80% by weight, more preferably at least 90% by weight, more preferably at least 95% by weight, most preferably at least 98% by weight of aluminum oxide.

The term “powder” in the context of the present invention encompass fine particles, i.e. those with an average particle size d₅₀ of typically less than 50 μm, preferably less than 10 μm.

“Fumed” aluminas also known as “pyrogenic” or “pyrogenically produced” aluminas, are prepared by means of pyrogenic processes, such as flame hydrolysis or flame oxidation. This involves oxidizing or hydrolysing of hydrolysable or oxidizable starting materials, generally in a hydrogen/oxygen flame. Starting materials used for pyrogenic methods include organic and inorganic substances. Aluminum trichloride is particularly suitable. The hydrophilic alumina thus obtained is generally in aggregated form. “Aggregated” is understood to mean that what are called primary particles, which are formed at first in the fumed process, become firmly bonded to one another later in the reaction to form a three-dimensional network. The primary particles are substantially free of pores and have free hydroxyl groups on their surface. Such hydrophilic aluminas can, as required, be hydrophobized, for example by treatment with reactive silanes.

It is known to produce pyrogenic mixed oxides by simultaneously reacting at least two different metal sources in the form of volatile metal compounds, for example chlorides, in a H₂/O₂ flame. All components of thus prepared mixed oxides, are generally distributed homogeneously in the whole mixed oxide material as opposed to the other kinds of materials like mechanical mixtures of several metal oxides, doped metal oxides and suchlike. In the latter case, e.g. for the mixture of several metal oxides, separated domains of the corresponding pure oxides may be present, which determine the properties of such mixtures.

The inventive fumed alumina powder may comprise different crystallographic phases, such as alpha-, theta-, delta-, gamma-Al₂O₃ and amorphous alumina. The content of these phases can be determined by X-ray diffraction analysis method (XRD). For such quantitative determination, the measured X-Ray diffraction patterns of the tested sample are compared with those of the reference samples containing the known content of the corresponding crystallographic phases.

The inventive fumed alumina powder comprises less than 5%, preferably less than 3%, more preferably less than 1%, more preferably essentially no alpha-Al₂O₃, as determined by XRD analysis. “Essentially no alpha-Al₂O₃, as determined by XRD analysis” means in the context of the present invention that no peaks corresponding to alpha-Al₂O₃ can be identified in the X-Ray crystallographic image of the sample.

The surface untreated fumed alumina powder according to the invention preferably has a number mean equivalent circular diameter (ECD) of primary particles, also referred to as primary crystallites, d_{p_ECD} of 5 nm to 150 nm, preferably 8 nm to 100 nm, more preferably 10 nm to 80 nm. The mean equivalent circular diameter (ECD) of primary particles d_{p_ECD} can be determined by transmission electron microscopy (TEM) analysis according to ISO 21363. At least 100 particles, preferably at least 300 particles, more preferably at least 500 particles should be analysed to calculate a representative value of d_{p_ECD}.

As it is generally known from the prior art, the average primary particle size of fumed alumina is approximately reversibly proportional to its BET surface area, i.e. fumed aluminas with higher BET surface areas have proportionally lower mean primary particle sizes. The surface untreated fumed alumina powder according to the invention preferably has a number mean equivalent circular diameter (ECD) of primary particles d_{p_ECD} (in nanometres), as determined by transmission electron microscopy (TEM) analysis according to ISO 21363, of at least 1100/(BETₐₗᵤₘᵢₙₐ in m²/g), more preferably of from 1100/(BETₐₗᵤₘᵢₙₐ in m²/g) to 1500/(BETₐₗᵤₘᵢₙₐ in m²/g), more preferably of from 1120/(BETₐₗᵤₘᵢₙₐ in m²/g) to 1400/(BETₐₗᵤₘᵢₙₐ in m²/g), more preferably of from 1150/(BETₐₗᵤₘᵢₙₐ in m²/g) to 1300/(BETₐₗᵤₘᵢₙₐ in m²/g), more preferably of from 1170/(BETₐₗᵤₘᵢₙₐ in m²/g) to 1280/(BETₐₗᵤₘᵢₙₐ in m²/g), more preferably of from 1200/(BETₐₗᵤₘᵢₙₐ in m²/g) to 1260/(BETₐₗᵤₘᵢₙₐ in m²/g), where BETₐₗᵤₘᵢₙₐ is a surface area of the alumina in m²/g. Thus, thermal treatment according to the invention leads to a slight increasing of the primary particle size in the obtained fumed aluminas of the invention.

Inventive surface unmodified fumed alumina powder has a reduced content of absorbed water, when compared to conventional fumed aluminum oxides.

A part of this absorbed water is weakly bound to Al₂O₃ and can be removed by drying, e.g. at 150° C. for 2 hours. Another part of the absorbed water is bound to Al₂O₃ more strongly and cannot be removed upon drying at 150° C. for 2 hours.

It has been found that the content of this strongly bound water is practically independent of the storage conditions and remains nearly constant upon storage under normal conditions, i.e. ambient temperature and typical air humidity.

The water content KF₁₅₀ of the inventive surface unmodified fumed alumina dried at 150° C. for 2 hours, can be determined by Karl-Fischer titration method. This Karl Fischer titration may be performed using any suitable Karl Fischer titrator, e.g. according to STN ISO 760.

The absolute water content of the inventive fumed alumina powders depends nearly linear on its BET surface area. It has been surprisingly found that a specific reduced ratio R of the water content of the fumed alumina to its surface area is characteristic for all fumed alumina powders according to the invention independent of their BET surface area.

Thus, the ratio R₁₅₀=KF₁₅₀/BET of the water content KF₁₅₀ of the inventive surface unmodified fumed alumina powder in % by weight, as determined by Karl Fischer titration method after drying of the inventive surface untreated fumed alumina powder at 150° C. for 2 hours, to its BET surface area in m²/g is not more than 0.0122 wt %×g/m², more preferably not more than 0.0120 wt %×g/m², more preferably not more than 0.0118 wt %×g/m², more preferably not more than 0.0116 wt %×g/m², more preferably not more than 0.0114 wt %×g/m², more preferably not more than 0.0112 wt %×g/m², more preferably not more than 0.0110 wt %×g/m², more preferably not more than 0.0108 wt %×g/m², more preferably not more than 0.0106 wt %×g/m², more preferably not more than 0.0104 wt %×g/m², more preferably not more than 0.0102 wt %×g/m², more preferably not more than 0.0100 wt %×g/m², more preferably not more than 0.0098 wt %×g/m², more preferably not more than 0.0096 wt %×g/m², more preferably not more than 0.0094 wt %×g/m², more preferably not more than 0.0092 wt %×g/m², more preferably not more than 0.0090 wt %×g/m², more preferably not more than 0.0088 wt %×g/m², more preferably not more than 0.0086 wt %×g/m², more preferably not more than 0.0084 wt %×g/m².

Total water content KF₀ of the inventive surface untreated fumed alumina powder comprising both weakly and strongly bound water can be determined by Karl Fischer titration method of the alumina without pre-drying.

The ratio R₀=KF₀/BET of the total water content KF₀ of the inventive surface unmodified fumed alumina powder in % by weight, as determined by Karl Fischer titration method, to its BET surface area in m²/g is preferably not more than 0.0385 wt %×g/m², more preferably not more than 0.0380 wt %×g/m², more preferably not more than 0.0375 wt %×g/m², more preferably not more than 0.0370 wt %×g/m², more preferably not more than 0.0360 wt %×g/m², more preferably not more than 0.0340 wt %×g/m², more preferably not more than 0.0300 wt %×g/m², more preferably not more than 0.0290 wt %×g/m², more preferably not more than 0.0280 wt %×g/m², more preferably not more than 0.0270 wt %×g/m², more preferably not more than 0.0260 wt %×g/m², more preferably not more than 0.0250 wt %×g/m², more preferably not more than 0.0240 wt %×g/m², more preferably not more than 0.0230 wt %×g/m², more preferably not more than 0.0220 wt %×g/m².

The term “surface unmodified” means in the context of the invention with respect to the fumed alumina powder that the alumina it is not surface treated, i.e. it is not modified with any surface treatment agent and is therefore hydrophilic in nature.

The surface unmodified fumed alumina powder according to the invention preferably has a carbon content of less than 1.0% by weight, preferably less than 0.5% by weight, more preferably less than 0.3% by weight, more preferably less than 0.2% by weight, even more preferably less than 0.1% by weight, still even more preferably less than 0.05% by weight. The carbon content can be determined by elemental analysis according to EN IS03262-20:2000 (Chapter 8).

The surface unmodified fumed alumina powder of the present invention preferably has a methanol wettability of not more than 15% by volume, more preferably of not more than 10% by volume, more preferably of not more than 5% by volume, especially preferably of about 0% by volume of methanol in a methanol/water mixture. Methanol wettability of the metal oxide powders, such as the inventive fumed alumina, can be determined, as described in detail, for example, in WO2011/076518 A1, pages 5-6.

The surface unmodified fumed alumina powder according to the present invention has a numerical average particle size d₅₀ of less than 5 μm, more preferably from 0.01 μm to 5.0 μm, more preferably from 0.03 μm to 3.0 μm, more preferably from 0.05 μm to 2.0 μm, more preferably from 0.06 μm to 1.5 μm, more preferably from 0.07 μm to 1.0 μm, more preferably from 0.08 μm to 0.90 μm, more preferably from 0.10 μm to 0.80 μm, as determined by static light scattering (SLS) after 120 seconds of ultrasonic treatment at 25° C. of a 5% by weight dispersion of the alumina in water. The resulting measured particle size distribution is used to define the average value d₅₀, which reflects the particle size not exceeded by 50% of all particles, as the numerical average particle size.

The inventive surface unmodified fumed alumina powder preferably has a particle size d₅₀ of less than 12 μm, preferably not more than 10 μm, more preferably not more than 8 μm, more preferably not more than 6 μm, more preferably not more than 4 μm, more preferably from 0.20 μm to 4 μm, more preferably from 0.20 μm to 2 μm, as determined by static light scattering (SLS) after 120 s of ultrasonic treatment at 25° C. of a 5% by weight dispersion of the alumina in water. The resulting measured particle size distribution is used to define the d₉₀ value, which reflects the particle size not exceeded by 90% of all particles.

The surface unmodified fumed alumina powder of the invention preferably has a relatively narrow particle size distribution, which can be characterized by a value of span (d₉₀-d₁₀)/d₅₀ of particle size distribution of preferably less than 20.0, more preferably less than 15.0, more preferably 0.8-5.0, more preferably 1.0-4.0, more preferably 1.0-3.0. Surface unmodified fumed alumina powder with the above-mentioned relatively small particle size and a narrow particle size distribution has particularly good dispersibility in various compositions and is therefore preferential.

The surface unmodified fumed alumina powder of the invention preferably has a tamped density of not more than 300 g/L, more preferably of not more than 250 g/L, more preferably of 20 g/L to 250 g/L, more preferably of 20 g/L to 200 g/L, more preferably of 25 g/L to 150 g/L, more preferably of 30 g/L to 130 g/L. Tamped densities can be determined according to DIN ISO 787-11:1995.

The surface unmodified fumed alumina powder of the invention can have a BET surface area of greater than 10 m²/g, preferably of 20 m²/g to 220 m²/g, more preferably of 25 m²/g to 200 m²/g, more preferably of 30 m²/g to 180 m²/g, more preferably of 40 m²/g to 140 m²/g. The specific surface area, also referred to simply as BET surface area, can be determined according to DIN 9277:2014 by nitrogen adsorption in accordance with the Brunauer-Emmett-Teller method.

The inventive surface unmodified alumina powder preferably has a number of hydroxyl groups relative to BET surface area d_{OH} of 7.5 OH/nm² to 11.0 OH/nm², more preferably 8.0 OH/nm² to 10.0 OH/nm², as determined by reaction with lithium aluminium hydride, as described in detail on page 8, line 17 thru page 9, line 12 of EP 0725037 A1. This method is also described in Journal of Colloid and Interface Science, vol. 125, no. 1, (1988), pp. 61-68.

The surface unmodified fumed alumina powder according to the invention can be obtained after carrying out step A) of the inventive process described below.

### Surface Modified Fumed Alumina Powder

The reduced moisture content of the inventive surface unmodified fumed alumina may be significantly reduced further by surface treatment of the alumina.

The invention further provides surface modified fumed alumina powder obtained by surface treatment of the inventive surface untreated fumed alumina with a surface treatment agent selected from the group consisting of organosilanes, silazanes, acyclic polysiloxanes, cyclic polysiloxanes, and mixtures thereof.

In the present invention, the term “surface modified” is used in analogy to the term “surface treated” and relates to a chemical reaction of the surface untreated hydrophilic alumina with the corresponding surface treatment agent, which fully or partially modify free hydroxyl groups of alumina.

Some particularly useful surface treatment agents suitable for obtaining the inventive surface treated fumed alumina powder are described below for the surface treatment step B) of the inventive process.

The surface modified alumina powder of the invention can be hydrophilic or hydrophobic, depending on the chemical structure of the used surface treatment agent. Preferably, surface treatment agents imparting hydrophobic properties are used leading to the formation of the surface treated alumina powder with hydrophobic properties.

The term “hydrophobic” in the context of the present invention relates to the surface-treated alumina particles having a low affinity for polar media such as water. The extent of the hydrophobicity of the surface treated alumina powder can be determined via parameters including its methanol wettability, as described in detail, for example, in WO2011/076518 A1, pages 5-6. In pure water, a hydrophobic inorganic oxide, e.g. silica or alumina separates completely from the water and floats on the surface thereof without being wetted with the solvent. In pure methanol, by contrast, a hydrophobic oxide is distributed throughout the solvent volume; complete wetting takes place. In the measurement of methanol wettability, the tested oxide sample is mixed with different methanol/water mixtures and a maximum methanol content at which there is still no wetting of the oxide, i.e. 100% of the tested oxide remains separated from the test mixture, is determined. This methanol content in the methanol/water mixture in % by volume is called methanol wettability. The higher the level of such methanol wettability, the more hydrophobic is the inorganic oxide.

The surface modified fumed alumina powder of the present invention preferably has a methanol wettability of methanol content greater than 20% by volume, more preferably of 30% to 90% by volume, more preferably of 30% to 80% by volume, especially preferably of 35% to 75% by volume, most preferably of 40% to 70% by volume in a methanol/water mixture.

The surface modified fumed alumina powder according to the invention can have a carbon content of from 0.2% to 10% by weight, preferably from 0.3% to 7% by weight, more preferably from 0.4% to 5% by weight, more preferably from 0.5% to 4% by weight, more preferably from 0.5% to 3.5% by weight, more preferably from 0.5% to 3.2% by weight, more preferably from 0.5% to 3.0% by weight, more preferably from 0.5% to 2.5% by weigh, more preferably from 0.5% to 2.0% by weigh, more preferably from 0.5% to 1.5% by weigh as determined by elemental analysis. Elemental analysis can be performed according to EN IS03262-20:2000 (Chapter 8). The analysed sample is weighed into a ceramic crucible, provided with combustion additives and heated in an induction furnace under an oxygen flow. The carbon present is oxidized to CO₂. The amount of CO₂ gas is quantified by infrared detectors.

The ratio R₀=KF₀/BET of the total water content KF₀ of the inventive surface modified fumed alumina powder in % by weight, as determined by Karl Fischer titration method, to BET surface area in m²/g is preferably not more than 0.025 wt %×g/m², more preferably not more than 0.022 wt %×g/m², more preferably not more than 0.020 wt %×g/m², more preferably not more than 0.015 wt %×g/m², more preferably not more than 0.010 wt %×g/m², more preferably not more than 0.005 wt %×g/m².

Many physico-chemical properties of the surface modified fumed alumina of the invention correspond to those described above for its precursor, the inventive surface unmodified fumed alumina.

Thus, crystal phase composition of the inventive surface unmodified fumed alumina described in detail above usually does not change significantly during its surface modification and therefore corresponds to the crystal phase composition of the inventive surface modified fumed alumina. The same holds true for values of the particle size d₅₀, d₉₀, the span of particle size distribution (d₉₀-d₁₀)/d₅₀, determined by SLS method. However, these values are then preferably determined by static light scattering (SLS) after 120 s of ultrasonic treatment at 25° C. of a 5% by weight dispersion of the surface modified alumina in methanol instead of water used for SLS measurements for surface unmodified fumed alumina.

The preferable value ranges of the BET surface area, of the tamped density and of the average primary particle size d_{p_ECD} of the inventive surface unmodified fumed alumina powder described above correspond to those of the inventive surface modified fumed alumina powder.

### Process for Producing the Fumed Alumina Powder

### Step A) of the Inventive Process

The invention further provides a process for producing fumed alumina powder according to the invention comprising
step A)—subjecting a surface untreated fumed alumina powder
with a particle size d₅₀ of less than 5 μm, as determined in an aqueous dispersion by a static light scattering method after 120 seconds of ultrasonic treatment,
and comprising less than 5% by weight of alpha-Al₂O₃, as determined by XRD analysis,
to thermal treatment at a temperature of 250° C. to 1250° C. for 5 min to 5 h,
wherein essentially no water is added before, during or after carrying out step A) and
wherein the temperature and the duration of the thermal treatment are chosen so that BET of the alumina is decreased by at most 23% relative to BET surface area of the employed thermally and surface untreated fumed alumina powder.

Thermal treatment of the surface untreated fumed alumina powder in the inventive process is conducted at a temperature of 250° C. to 1250° C., preferably at 300° C.-1250° C., more preferably at 400° C.-1200° C., more preferably at 500° C.-1200° C., more preferably at 500° C.-1100° C., more preferably at 700° C.-1200° C., more preferably at 700° C.-1100° C. more preferably at 1000° C.-1200° C. and more preferably at 1000° C.-1100° C. The duration of this thermal treatment depends on the temperature applied, and is generally from 5 minutes to 5 hours, preferably from 10 minutes to 4 hours, more preferably from 20 minutes to 3 hours, more preferably from 30 minutes to 2 hours.

It has been observed that the duration of the thermal treatment step may greatly impact the properties of the obtained fumed alumina powders. Thus, if the duration of the thermal treatment step carried out at 250-1250° C. is less than 5 minutes, usually no significant reducing in moisture content of the alumina is observed, especially if the starting material for thermal treatment is pre-dried prior to thermal treatment and as such is not wet and e.g. has a water content of not more than 3% by weight, as determined by Karl Fischer titration method. Conversely, the duration of the thermal treatment step of more than 5 hours usually does not bring about any significant further change in the water content of the obtained alumina, while particle size of the obtained particles may become larger.

Thermal treatment in the inventive process may lead to reducing the number of free hydroxyl groups by condensation of such groups and formation of O—Al—O bridges.

This process may be accompanied by reducing the BET surface area of the obtained fumed alumina.

Importantly, it has been found that under the conditions employed in the inventive process, a significant reducing of the moisture content can be achieved without any substantial reducing of the BET surface area of the fumed alumina.

Thus, the temperature and the duration of the thermal treatment in step A) of the inventive process are chosen so that BET of the alumina is decreased by at most 23%, preferably by at most 20%, more preferably by at most 17%, more preferably by at most 14%, more preferably by at most 11% relative to BET surface area of the employed thermally and surface untreated fumed alumina powder.

Thermal treatment may also lead to crystal phase change and densification of the fumed alumina as well as to larger primary particles of the obtained thermally treated fumed alumina.

Thermal treatment in the inventive process may be carried out discontinuously (batchwise), semi-continuously or preferably continuously.

The “duration of the thermal treatment” of a discontinuous process is defined as a whole period of time when the surface untreated fumed alumina is being heated at the specified temperature. For a semi-continuous or continuous process, the “duration of the thermal treatment” corresponds to the mean residence time of the surface untreated fumed alumina powder at the specified temperature of thermal treatment.

The inventive process is preferably carried out continuously, with the mean residence time of the surface untreated fumed alumina powder in the thermal treatment step A) of from 10 min to 3 h.

In the inventive process, thermal treatment is preferably carried out while the fumed alumina powder is in motion, preferably in constant motion during the process, i.e. alumina is being moved during the thermal treatment. Such a “dynamic” process is an opposite of a “static” thermal treatment process, wherein alumina particles are not moved, e.g. are present in layers during a thermal treatment e.g. in a muffle furnace.

It has been surprisingly found that such a dynamic thermal treatment process in combination with suitable temperature and duration of the thermal treatment allows producing of uniform small particles with a relatively narrow particle size distribution showing particularly good dispersibility in various compositions.

The inventive process is preferably carried out in any suitable apparatus allowing keeping the alumina powder at the above-specified temperature for a specified period of time, while moving the alumina. Some suitable apparatuses are fluidized bed reactors and rotary kilns. Rotary kilns, particularly those with a diameter of 1 cm to 2 m, preferably 5 cm to 1 m, more preferably 10 cm to 50 cm, are preferably used in the inventive process.

The fumed alumina powder is preferably being moved at the motion rate of a least 1 cm/min, more preferably at least 10 cm/min, more preferably at least 25 cm/min, more preferably at least 50 cm/min, at least temporally during the thermal treatment step A). Preferably, the alumina is being moved at this motion rate continuously for the whole duration of the thermal treatment step. The motion rate in a rotary kiln corresponds to circumferential speed of this reactor type. The motion rate in a fluidized bed reactor corresponds to the carrier gas flow rate (fluidization velocity).

Essentially no water is added before, during or after carrying out step A) of the inventive process. In this way, the additional absorption of water on the fumed alumina can be avoided and thermally treated alumina powders with a lower water content may be obtained.

“Essentially no water” means with respect to the inventive process that the content of the water added before, during or after carrying out step A) of the inventive process, relative to fumed alumina weight, is preferably less than 5% by weight, more preferably less than 3% by weight, more preferably less than 1% by weight, more preferably less than 0.5% by weight.

The thermal treatment step A) can be conducted under flow of a gas, such as, for example, air or nitrogen, the gas preferably being essentially free of water or pre-dried.

“Essentially free of water” means with respect to the gas that water content of the gas used in step A) of the inventive process, is preferably less than 5% by volume, more preferably less than 3% by volume, more preferably less than 1% by volume, more preferably less than 0.5% by volume, more preferably no steam or water vapour at all is added to the gas prior to use.

### Step B) of the Inventive Process

The inventive process for producing fumed alumina powder can further comprise
step B)—surface treatment of the of the fumed alumina powder obtained in step A) with a surface treatment agent selected from the group consisting of organosilanes, silazanes, acyclic polysiloxanes, cyclic polysiloxanes, and mixtures thereof.

The preferred organosilanes are e.g. alkyl organosilanes of the general formulas (Ia) and (Ib):

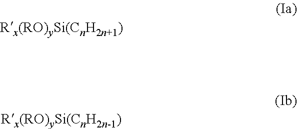

wherein
R=alkyl, such as, for example, methyl-, ethyl-, n-propyl-, i-propyl-, butyl-
R′=alkyl or cycloalkyl, such as, for example, methyl, ethyl, n-propyl, i-propyl, butyl, cyclohexyl, octyl, hexadecyl.

$$n = 1 - 20$$

$$x + y = 3$$

$$x = 0 - 2 ,$$

$$and y = 1 - 3.$$

Among alkyl organosilanes of formulas (Ia) and (Ib), particularly preferred are octyltrimethoxysilane, octyltriethoxysilane, hexadecyltrimethoxysilane, hexadecyltriethoxysilane.

Organosilanes used for surface treatment may contain halogens such as Cl or Br. Particularly preferred are the halogenated organosilanes of the following types:
organosilanes of the general formulas (IIa) and (IIb):

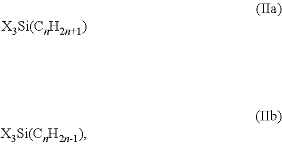

wherein X=Cl, Br, n=1-20;
organosilanes of the general formulas (IIIa) and (IIIb):

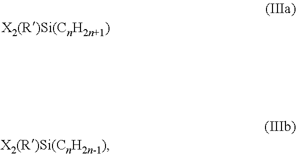

wherein X=Cl, Br R′=alkyl, such as, for example, methyl, ethyl, n-propyl, i-propyl, butyl, cycloalkyl such as cyclohexyl
n=1-20;
organosilanes of the general formulas (IVa) and (IVb):

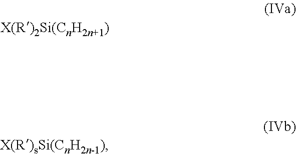

wherein X=Cl, Br
R′=alkyl, such as, for example, methyl, ethyl, n-propyl, i-propyl, butyl, cycloalkyl such as cyclohexyl
n=1-20

Among halogenated organosilanes of formula (II)-(IV), particularly preferred are dimethyldichlorosilane and chloro trimethylsilane.

The used organosilanes can also contain other than alkyl or halogen substituents, e.g. fluorine substituents or some functional groups. Preferably used are functionalized organosilanes of the general formula (V):

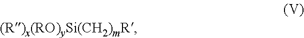

wherein
R″=alkyl, such as methyl, ethyl, propyl, or halogen such as Cl or Br,
R=alkyl, such as methyl, ethyl, propyl,

$$x + y = 3$$

$$x = 0 - 2 ,$$

$$y = 1 - 3 ,$$

$$m = 1 - 20 ,$$

R′=methyl-, aryl (for example, phenyl or substituted phenyl residues), heteroaryl —C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C═CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sr—(CH₂)₃Si(OR)₆, —SH, —NR¹R²R³ (R¹=alkyl, aryl; R²=H, alkyl, aryl; R³=H, alkyl, aryl, benzyl, C₂H₄NR⁴R⁵ with R⁴=H, alkyl and R⁵=H, alkyl).

Among functionalized organosilanes of formula (V), particularly preferred are 3-methacryloxypropyltrimethoxysilane, 3-methacryloxypropyltriethoxysilane, glycidyloxypropyltrimethoxysilane, glycidyloxypropyltriethoxysilane, aminopropyltriethoxysilane.

Silazanes of the general formula R′R₂Si—NH—SiR₂R′(VI), wherein R=alkyl, such as methyl, ethyl, propyl; R′=alkyl, vinyl, are also suitable as surface treatment agents. The most preferred silazane of formula (VI) is hexamethyldisilazane (HMDS).

Also suitable as surface treatment agents are cyclic polysiloxanes, such as octamethylcyclotetrasiloxane (D4), decamethylcyclopentasiloxane (D5), dodecamethylcyclohexasiloxane (D6), hexamethylcyclotrisiloxane (D6). Most preferably among cyclic polysiloxanes, D4 is used.

Another useful type of surface treatment agent is polysiloxanes or silicone oils of the general formula (VII):

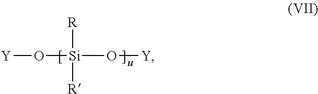

wherein
Y=H, CH₃, CₙH₂ₙ₊₁, wherein n=1-20, Si(CH₃)ₐX_{b},
wherein a=2-3, b=0 or 1, a+b=3,
X=H, OH, OCH₃, CₘH₂ₘ₊₁, wherein m=1-20.
R, R′=alkyl, such as CₒH₂ₒ₊₁, wherein o=1 to 20, aryl, such as phenyl and substituted phenyl residues, heteroaryl, (CH₂)ₖ—NH₂, wherein k=1-10, H,
u=2-1000, preferably u=3-100.

Most preferably among polysiloxanes and silicone oils of the formula (VII), polydimethylsiloxanes are used as surface treatment agents. Such polydimethylsiloxanes usually have a molar mass of 162 g/mol to 7500 g/mol, a density of 0.76 g/mL to 1.07 g/mL and viscosities of 0.6 mPa*s to 1 000 000 mPa*s.

Water can be used additionally to the surface treatment agent in step B) of the inventive process. The molar ratio of water to the surface treatment agent in step B) of the inventive process is preferably from 0.1 to 100, more preferably 0.5 to 50, more preferably 1.0 to 10, more preferably 1.2 to 9, more preferably 1.5 to 8, more preferably 2 to 7.

However, if a surface treated alumina powder with a low water content should be obtained, the amount of used in process water should be minimized and ideally no water at all should be added during the process steps. Thus, essentially no water is preferably added before, during or after carrying out step B). The term “essentially no water” relates in the context of the present invention to added water amount of less than 1%, preferably less than 0.5%, more preferably less than 0.1%, more preferably less than 0.01% by weight of the employed in step B) fumed alumina powder, most preferably no water at all.

The surface treatment agent and optionally water can be used both in vapour and liquid form in the inventive process.

Step B) of the inventive process can be carried out at a temperature of 10° C. to 250° C. for 1 minute to 24 hours. The time and the duration of step B) can be selected according to the specific requirements for the process and/or targeted alumina properties. Thus, the lower treatment temperature usually requires the longer hydrophobization times. In one preferred embodiment of the invention, hydrophobizing of the fumed alumina powder is performed at 10° C. to 80° C. for 3 hours to 24 hours, preferably for 5 hours to 24 hours. In another preferred embodiment of the invention, step B) of the process is carried out at 90° C. to 200° C., preferably at 100° C. to 180° C., most preferably at 120° C. to 160° C. for 0.5 hours to 10 hours, preferably for 1 hours to 8 hours. Step B) of the process according to the invention can be carried out under the pressure of 0.1 bar to 10 bar, preferably under 0.5 bar to 8 bar, more preferably at 1 bar to 7 bar, most preferably under 1.1 bar to 5 bar. Most preferably, step B) is performed in a closed system under natural vapour pressure of the used surface treatment agent at the reaction temperature.

In step B) of the inventive process, the fumed alumina powder subjected to thermal treatment in step A) is preferably sprayed with a liquid surface treatment agent at ambient temperature (about 25° C.) and the mixture is subsequently treated thermally at a temperature of 50° C. to 400° C. over a period of 1 hours to 6 hours.

An alternative method for surface treatment in step B) can be carried out by treating the fumed alumina powder subjected to thermal treatment in step A) with a surface treatment agent, with the surface treatment agent being in the vapour form and subsequently treating the mixture thermally at a temperature of 50° C. to 800° C. over a period of 0.5 hours to 6 hours.

The thermal treatment after the surface treatment in step B) can be conducted under protective gas, such as, for example, nitrogen. The surface treatment can be carried out in heatable mixers and dryers with spraying devices, either continuously or batchwise. Suitable devices can be, for example, ploughshare mixers or plate, cyclone, or fluidized bed dryers.

The amount of the surface treatment agent used depends on the type of the particles and of the surface treatment agent applied. However, usually from 1% to 25%, preferably 2%-20%, more preferably 5%-18%, by weight of the surface treatment agent related to the amount of the fumed alumina powder subjected to thermal treatment in step A), is employed.

The required amount of the surface treatment agent can depend on the BET surface area of the fumed alumina powder employed. Thus, preferably, 0.1 μmol-100 μmol, more preferably 1 μmol-50 μmol, more preferably 3.0 μmol-20 μmol of the surface treatment agent per m² of the BET specific surface area of the fumed alumina powder subjected to thermal treatment in step A), is employed.

In optional step C) of the inventive process, the fumed alumina powder subjected to thermal treatment in step A) and/or the fumed alumina powder obtained in step B) of the process is crushed, grinded or milled to reduce the mean particle size of the obtained alumina particles.

Crushing in optional step C) of the inventive processes can be realized by means of any suitable for this purpose machine, e.g. by a suitable mill.

However, in most cases, carrying out the optional step C) of the inventive process is unnecessary and even not desirable. Though crushing or milling of coarse alumina particles usually provides alumina particles with reduced mean particle sizes, yet such particles show relatively broad particle size distributions. Such particles usually contain relatively large ratios of fines, complicating handling of these crushed/milled particles.

Therefore, the inventive process preferably does not contain any crushing, grinding and/or milling steps.

### Composition Comprising the Fumed Alumina Powder

Another object of the present invention is a composition comprising the inventive surface unmodified fumed alumina powder and/or the inventive surface modified fumed alumina powder.

The composition according to the invention can comprise at least one binder, which joins the individual parts of the composition to one another and optionally to one or more fillers and/or other additives and can thus improve the mechanical properties of the composition. Such a binder can contain organic or inorganic substances. The binder optionally contains reactive organic substances. Organic binders can, for example, be selected from the group consisting of (meth)acrylates, alkyd resins, epoxy resins, gum Arabic, casein, vegetable oils, polyurethanes, silicone resins, wax, cellulose glue and mixtures thereof. Such organic substances can lead to the curing of the composition used, for example by evaporation of the solvents, polymerization, crosslinking reaction or another type of physical or chemical transformation. Such curing can take place, for example, thermally or under the action of UV radiation or other radiation. Both single (one) component (1-C) and multicomponent systems, particularly two component systems (2-C) can be applied as binder. Additional to the binder or instead of this, the inventive composition can also contain matrix polymers, such as polyolefin resins, e.g. polyethylene or polypropylene, polyester resins, e.g. polyethylene terephthalate, polyacrylonitrile resin, cellulose resin, or a mixture thereof. The inventive fumed alumina powder can be incorporated in such matrix polymers or form a coating on the surface thereof.

Apart from the fumed alumina powder and the binder, the composition according to the invention can additionally contain at least one solvent and/or filler and/or other additives.

The solvent used in the composition of the invention can be selected from the group consisting of water, alcohols, aliphatic and aromatic hydrocarbons, ethers, esters, aldehydes, ketones and the mixtures thereof. For example, the solvent used can be methanol, ethanol, propanol, butanol, pentane, hexane, benzene, toluene, xylene, diethyl ether, methyl tert-butyl ether, ethyl acetate, and acetone. Particularly preferably, the solvents used in the composition have a boiling point of less than 300° C., particularly preferably less than 200° C. Such relatively volatile solvents can be easily evaporated or vaporized during the curing of the composition according to the invention.

### Use of the Fumed Alumina Powder

The inventive surface modified and/or the inventive surface modified alumina powder can be used as a constituent of paints or coatings, silicones, pharmaceutical or cosmetic preparations, adhesives or sealants, toner compositions, lithium ion batteries, especially separators, electrodes and/or electrolyte thereof, as well as for modifying rheology properties of liquid systems, as anti-settling agent, for improving flowability of powders, for improving mechanical and/or optical properties of silicone compositions, as a catalyst carrier, in chemical mechanical planarization (CMP) applications, for thermal insulation.

### BRIEF DESCRIPTION OF THE DRAWINGS

FIGS. 1A and 1B show transmission electron microscopy (TEM) images of starting material 2.

FIGS. 2A and 2B show transmission electron microscopy (TEM) images of thermally treated at 1200° C. starting material 2 (example 9).

FIG. 3 shows XRD image of thermally treated at 1200° C. starting material 2 (example 9).

FIG. 4 shows XRD image of thermally treated at 1300° C. starting material 2 (comparative example 3).

### EXAMPLES

### Analytical Methods.

Specific BET surface area [m²/g] was determined according to DIN 9277:2014 by nitrogen adsorption in accordance with the Brunauer-Emmett-Teller method.

The number of hydroxyl groups relative to BET surface area d_{OH} [OH/nm²] was determined by reaction of the pre-dried samples of alumina powders with lithium aluminium hydride solution as described in detail on page 8, line 17 thru page 9, line 12 of EP 0725037 A1. This method is also described in Journal of Colloid and Interface Science, vol. 125, no. 1, (1988), pp. 61-68.

Tamped density [g/L] was determined according to DIN ISO 787-11:1995 “General methods of test for pigments and extenders—Part 11: Determination of tamped volume and apparent density after tamping”.

Particle size distribution, i.e. values d₁₀, d₅₀, d₉₀ and span (d₉₀-d₁₀)/d₅₀ [μm] were measured by static light scattering (SLS) using laser diffraction particle size analyzer (HORIBA LA-950) after 120 s of ultrasonic treatment at 25° C. of a 5% by weight dispersion of the surface treated alumina in water.

Water content [wt. %] was determined by Karl Fischer titration using a Karl Fischer titrator.

Mean equivalent circle diameter (ECD) of the primary particles d_{p_ECD} was determined by transition electron microscopy (TEM) analogously to ISO 21363.

X-Ray diffraction analyses (XRD) were performed by means of a transmission diffractometer from Stoe & Cie Darmstadt, Germany using CuK alpha radiation, excitation 30 mA, 45 kV, OED. For quantitative determination of alpha-Al₂O₃, the measured X-Ray diffraction patterns of the tested sample were compared with those of the reference samples containing 100% and 80% of alpha-Al₂O₃.

### Starting Materials.

Fumed alumina with a BET surface area of 121 m²/g was prepared according to the description on page 35 of WO 2004108595 Al (aluminium oxide I) and used as starting material 1.

Fumed alumina with a BET surface area of 50 m²/g was prepared according to example 3 of WO 2006067127 Al and used as starting material 2. The mean primary particle size d_{p_ECD} (mean equivalent circle diameter, ECD, of the primary particles) of the particles determined by TEM analysis was found to be 21.2 nm (=1062/BET).

### Example 1

Starting material 1 was subjected to thermal treatment in a rotary kiln of ca. 160 mm diameter and 2 m length at 400° C. The mean residence time of the alumina in the rotary kiln was 1 hour. Rotational speed was set to 5 rpm resulting in a throughput of approximately 1 kg/h of alumina. Dry and filtered compressed air was fed continuously with a flow rate of ca. 1 m³/h to the kiln outlet (in counterflow to the thermally treated alumina flow) to provide preconditioned air for the convection in the tube. The process was smooth. No clogging of the rotary kiln was observed. Physico-chemical properties of the obtained thermally treated alumina are shown in Table 1.

Examples 2-4 and comparative examples 1-2 were carried out analogously to example 1 but applying thermal treatment temperatures of 700 to 1300° C. No clogging of the rotary kiln was observed in examples 2-4 at 700-1100° C., whereas in comparative example 1 (thermal treatment at 1200° C.), some clogging was observed. In comparative example 2 (thermal treatment at 1300° C.), so much clogging was observed that the experiment had to be stopped, the obtained product has not been further analyzed. Physico-chemical properties of the obtained thermally treated aluminas (except for comparative example 2) are shown in Table 1.

Table 1 shows the physicochemical properties of fumed alumina powders obtained by thermal treatment of starting material 1 (BET=121 m²/g, tamped density=52 g/L).

BET surface area, tamped density and particle size, as well the composition of crystal phases of the starting material 1 do not change much in examples 1-4, where the thermal treatment is carried out at a temperature of up to 1100° C. The total moisture content of the starting material 1 has been decreased from 4.76% down to 1.93-2.72 wt %, the content of the strongly bound water has been decreased from 1.54 wt % down to about 1 wt % in examples 1-4.

Conversely, at 1200° C. (comparative example 1) an abrupt reduction of the BET surface area (by 25.6%) and a significant increase of both the tamped density (increase by 26.9%) and the particle size, e.g. of d₅₀ value (dramatic increase from 0.11 to 3.63 μm), was observed (Table 1). No alpha phase of Al₂O₃ was observed in the XRD images of the samples from examples 1-4 and comparative example 1.

Comparative example 2 carried out at 1300° C. had to be stopped, as the used rotary kiln was congested precluding further carrying out the experiment.

### Example 5

Starting material 2 was subjected to thermal treatment in a rotary kiln of ca. 160 mm diameter and 2 m length at 400° C. The mean residence time of the alumina in the rotary kiln was 1 hour. Rotational speed was set to 5 rpm resulting in a throughput of approximately 1 kg/h of alumina. Dry and filtered compressed air was fed continuously with a flow rate of ca. 1 m³/h to the kiln outlet (in counterflow to the thermally treated alumina flow) to provide preconditioned air for the convection in the tube. The process was smooth. No clogging of the rotary kiln was observed. Physico-chemical properties of the obtained thermally treated alumina are shown in Table 2.

Examples 6-9 and comparative example 3 were carried out analogously to example 5 but applying thermal treatment temperatures of 700 to 1300° C. No clogging of the rotary kiln was observed in examples 6-9, whereas in comparative example 3, a significant clogging was observed. Physico-chemical properties of the obtained thermally treated aluminas are shown in Table 2. The mean primary particle size d_{p_ECD} (mean equivalent circle diameter, ECD, of the primary particles) of the particles obtained in example 9 determined by TEM analysis was found to be 27.6 nm (=1243/BET).

Table 2 shows the physicochemical properties of fumed alumina powders obtained by thermal treatment of starting material 2 (BET=50 m²/g, tamped density=95 g/L).

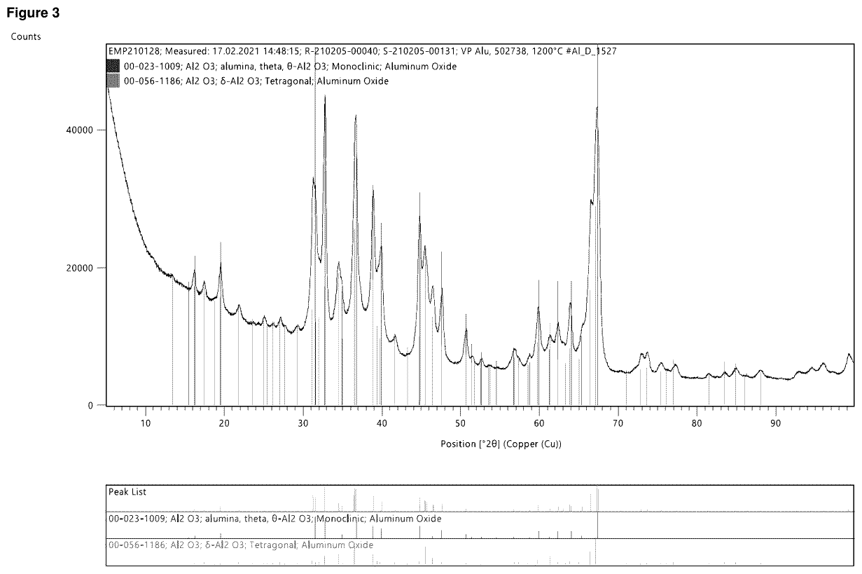

BET surface area, tamped density and particle size, as well the composition of crystal phases of the starting material 2 do not change much in examples 5-9 (FIG. 3 for example 9), where the thermal treatment is carried out at a temperature of up to 1200° C. The total moisture content of the starting material 2 has been decreased from 2.09% down to 0.98-1.25 wt %, the content of the strongly bound water has been decreased from 0.62 wt % down to about 0.45-0.55 wt % in examples 5-9.

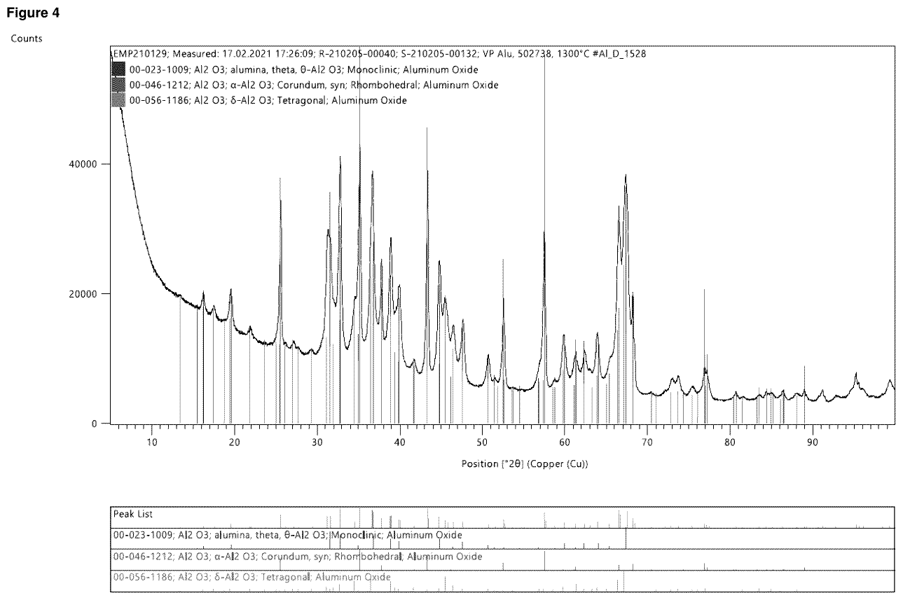

Conversely, at 1300° C. (comparative example 3) an abrupt reduction of the BET surface area (by 24%) and a significant increase of both the tamped density (increase by 42%) and the particle size, e.g. of d₅₀ value (dramatic increase from 0.11 to 2.48 μm), was observed along with a significant change of the crystallographic phase composition, particularly appearance of a significant amount of alpha-Al₂O₃(Table 2, FIG. 4).

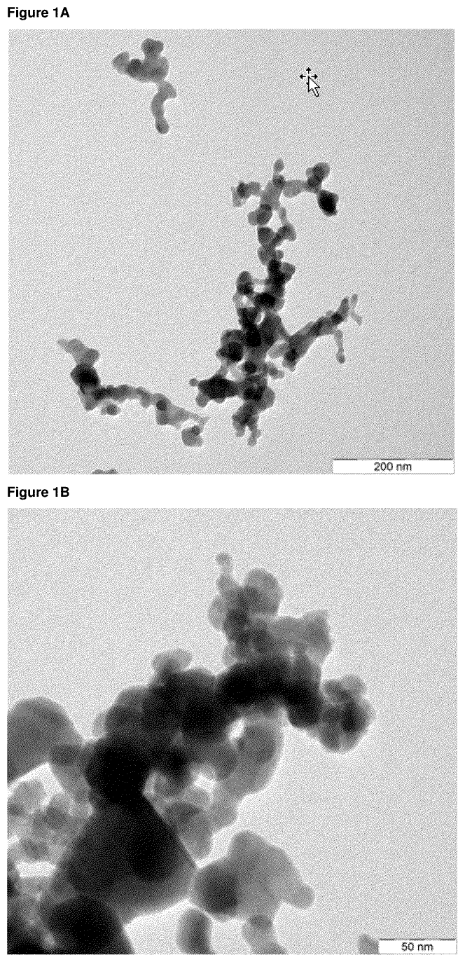

FIGS. 1A and 1B show transmission electron microscopy (TEM) images of starting material 2.

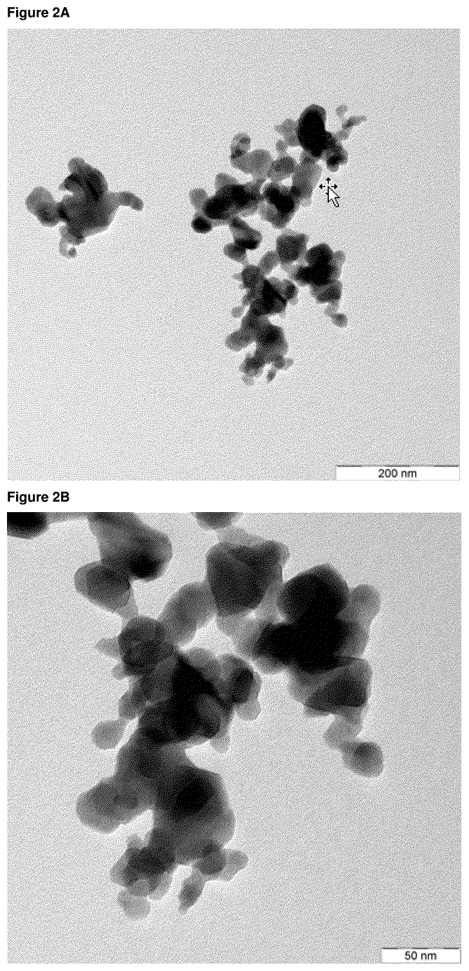

FIGS. 2A and 2B show transmission electron microscopy (TEM) images of thermally treated at 1200° C. starting material 2 (example 9). As it can be seen from TEM analyses, that the mean equivalent circular diameter of primary particles d_{p_ECD} of alumina increases from 21.2 nm (starting material 2) to 27.6 nm (example 9).

TABLE 1
Thermal treatment of starting material 1

| | Sample | | | | | | | | | | |
|---|---|---|---|---|---|---|---|---|---|---|---|
| | | | | | | | | | | | Water |
| | Thermal | | tamped | OH-group | Al₂O₃ | α-phase | | | | Water | content |
| | treatment | BET | density | density | phases | content | d₁₀^{a} | d₅₀^{a} | d₉₀^{a} | content | [%] after |
| Example | [° C.] | [m²/g] | [g/L] | [OH/nm²] | (XRD) | [%] | [μm] | [μm] | [μm] | [%]^{b} | drying^{c} |
| starting | — | 121 | 52 | 9.2 | γ, δ | 0 | 0.07 | 0.11 | 0.26 | 4.76 | 1.54 |
| material 1 | | | | | | | | | | | |
| example 1 | 400 | 119 | 47 | 9.0 | γ, δ | 0 | 0.08 | 0.15 | 0.37 | 2.72 | 1.02 |
| example 2 | 700 | 118 | 50 | 8.3 | γ, δ | 0 | 0.10 | 0.26 | 0.72 | 2.24 | 0.98 |
| example 3 | 1000 | 116 | 49 | 8.0 | γ, δ | 0 | 0.13 | 0.39 | 5.93 | 1.93 | 0.96 |
| example 4 | 1100 | 113 | 51 | 8.2 | γ, δ | 0 | 0.13 | 0.46 | 6.86 | 2.30 | 1.00 |
| comparative | 1200 | 90 | 66 | 9.9 | γ, δ | 0 | 0.14 | 3.63 | 7.46 | 2.12 | 0.86 |
| example 1 | | | | | | | | | | | |
| comparative | 1300 | | | | | | | | | | |
| example 2^{d} | | | | | | | | | | | |

^{a}determined by static light scattering (SLS) after 120 s of ultrasonic treatment at 25° C. of a 5% by weight dispersion of the alumina in water;
^{b}determined by Karl-Fischer titration;
^{c}determined by Karl-Fischer titration after drying of the sample at 150° C. for 2 h;
^{d}congestion of the rotary kiln, the experiment has been stopped, the product has not been analysed.

TABLE 2
Thermal treatment of starting material 2.

| | Sample | | | | | | | | | | |
|---|---|---|---|---|---|---|---|---|---|---|---|
| | | | | | | | | | | | Water |
| | | | | | | | | | | | content |
| | Thermal | | tamped | OH-group | Al₂O₃ | α-phase | | | | Water | [%] |
| | treatment | BET | density | density | phases | content | d₁₀^{a} | d₅₀^{a} | d₉₀^{a} | content | after |
| Example | [° C.] | [m²/g] | [g/L] | [OH/nm²] | (XRD) | [%] | [μm] | [μm] | [μm] | [%]^{b} | drying^{c} |
| starting | — | 50 | 95 | 10.0 | δ, θ | 0 | 0.07 | 0.11 | 0.21 | 2.09 | 0.62 |
| material 2 | | | | | | | | | | | |
| example 5 | 400 | 48 | 110 | 9.3 | δ, θ | 0 | 0.07 | 0.10 | 0.21 | 1.25 | 0.45 |
| example 6 | 700 | 48 | 113 | 9.4 | δ, θ | 0 | 0.09 | 0.24 | 0.50 | 1.17 | 0.49 |
| example 7 | 1000 | 47 | 117 | 9.7 | δ, θ | 0 | 0.11 | 0.31 | 1.66 | 1.01 | 0.49 |
| example 8 | 1100 | 47 | 106 | 9.3 | δ, θ | 0 | 0.21 | 0.42 | 3.81 | 1.13 | 0.55 |
| example 9 | 1200 | 45 | 110 | 10.6 | δ, θ | 0 | 0.18 | 0.53 | 6.58 | 0.98 | 0.47 |
| comparative | 1300 | 38 | 135 | 8.3 | α, δ, θ | 25 | 0.15 | 2.48 | 8.12 | 0.76 | 0.40 |
| example 3 | | | | | | | | | | | |

^{a}determined by static light scattering (SLS) after 120 s of ultrasonic treatment at 25° C. of a 5% by weight dispersion of the alumina in water;
^{b}determined by Karl-Fischer titration;
^{c}determined by Karl-Fischer titration after drying of the sample at 150° C. for 2 h.

1-15. (canceled)

16. A fumed alumina powder comprising:
a) less than 5% by weight of alpha-Al₂O₃, as determined by XRD analysis;
b) a numerical average particle size d₅₀ of less than 5 μm, as determined by static light scattering (SLS) after 120 s of ultrasonic treatment at 25° C. of a 5% by weight dispersion of the alumina in water;
c) a ratio R₁₅₀=KF₁₅₀/BET of the water content KF₁₅₀, as determined by Karl Fischer titration method after drying of the fumed alumina powder at 150° C. for 2 hours, to its BET surface area, of not more than 0.0122 wt %×g/m²;
and wherein the fumed alumina powder is surface unmodified.

17. The fumed alumina powder of claim 16, wherein essentially no alpha-Al₂O₃ is present as determined by XRD analysis.

18. The fumed alumina powder of claim 16, wherein the BET surface area of the alumina is from 20 m²/g to 220 m²/g.

19. The fumed alumina powder of claim 16, wherein the tamped density of the alumina is not more than 250 g/L.

20. The fumed alumina of claim 16, wherein the number mean equivalent circular diameter of primary particles of the alumina d_{p_ECD} in nanometers, as determined by transmission electron microscopy (TEM) according to ISO 21363, is at least 1100/(BETₐₗᵤₘᵢₙₐ surface area of the alumina in m²/g).

21. The fumed alumina powder of claim 16, wherein the alumina has a ratio R₀=KF₀/BET of the water content KF₀ as determined by Karl Fischer titration method, to BET surface area of not more than 0.0385 wt %×g/m².

22. The fumed alumina powder of claim 16, further comprising surface modification due to treatment with a surface treatment agent selected from the group consisting of: organosilanes; silazanes; acyclic polysiloxanes; cyclic polysiloxanes; and mixtures thereof.

23. The fumed alumina powder of claim 17, wherein the BET surface area of the alumina is from 20 m²/g to 220 m²/g and the tamped density is not more than 250 g/L.

24. The fumed alumina powder of claim 17, further comprising surface modification due to treatment with a surface treatment agent selected from the group consisting of: organosilanes; silazanes; acyclic polysiloxanes; cyclic polysiloxanes; and mixtures thereof.

25. The fumed alumina of claim 17, wherein:
a) the number mean equivalent circular diameter of primary particles of the alumina d_{p_ECD} in nanometers, as determined by transmission electron microscopy (TEM) according to ISO 21363, is at least 1100/(BETₐₗᵤₘᵢₙₐ surface area of the alumina in m²/g); and
b) the fumed alumina has a ratio R₀=KF₀/BET of not more than 0.0385 wt %×g/m².

26. A process for producing the fumed alumina powder of claim 16, comprising as step A): subjecting a surface untreated fumed alumina powder to thermal treatment at a temperature of 250° C. to 1250° C. for 5 min to 5 h, wherein:
the untreated fumed alumina powder has a particle size d₅₀ of less than 5 μm, as determined in an aqueous dispersion by a static light scattering method after 120 s of ultrasonic treatment, and comprises less than 5% by weight of alpha-Al₂O₃, as determined by XRD analysis;
essentially no water is added before, during or after carrying out step A);
the temperature and the duration of the thermal treatment are chosen so that the BET surface area of the alumina is decreased by, at most, 23% relative to the BET surface area prior to thermal treatment.

27. The process of claim 26, wherein the fumed alumina powder produced comprises essentially no alpha-Al₂O₃ as determined by XRD analysis.

28. The process of claim 26, wherein the fumed alumina powder produced has a BET surface area of from 20 m²/g to 220 m²/g and a tamped density of not more than 250 g/L.

29. The process of claim 26, wherein the fumed alumina powder produced comprises:
a) a number mean equivalent circular diameter of primary particles of the alumina d_{p_ECD} in nanometers, as determined by transmission electron microscopy (TEM) according to ISO 21363, of at least 1100/(BETₐₗᵤₘᵢₙₐ surface area of the alumina in m²/g) and
b) a ratio R₀=KF₀/BET of not more than 0.0385 wt %×g/m².

30. The process of claim 26, wherein the thermal treatment is carried out while the fumed alumina powder is in motion.

31. The process of claim 26, wherein the fumed alumina powder is being moved at a rate of at least 1 cm/min during the thermal treatment step A).

32. The process of claim 26, wherein the thermal treatment is carried out in a rotary kiln.

33. The process of claim 26, further comprising as step B): surface treating the fumed alumina powder obtained in step A) with a surface treatment agent selected from the group consisting of: organosilanes; silazanes; acyclic polysiloxanes; cyclic polysiloxanes; and mixtures thereof.

34. The process of claim 33, wherein essentially no water is added before, during or after carrying out step B).

35. A composition comprising the fumed alumina powder of claim 16, wherein said composition is a paint or coating; silicone; pharmaceutical or cosmetic preparation; adhesive or sealant; toner; a component of a lithium ion battery; a liquid wherein the fumed alumina powder acts to alter the rheology properties of the liquid or as an anti-settling agent; a powder wherein the fumed alumina powder acts to improve flowability; a catalyst; a composition used in chemical mechanical planarization (CMP) applications; or a thermal insulator.
